(19) United States
(12) Patent Application Publication
(10) Pub. No.: US 2005/0047694 A1
(43) Pub. Date: Mar. 3, 2005

(54) Rolling bearing

(76) Inventors: Masayuki Nozaki, Mie (JP); Takumi Fujita, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/927,445

(22) Filed: Aug. 27, 2004

(30) Foreign Application Priority Data
Aug. 29, 2003 (JP) 2003-306610

(51) Int. Cl. F16C 33/32; F16C 33/62

(52) U.S. Cl. 384/492

(57) ABSTRACT

A ball bearing for use in a high-temperature, high-speed, light-load environment is proposed which includes inner and outer rings formed of heat-resistant bearing steel M50. A nitrided layer which is formed of a diffusion layer only is formed on each of the surfaces of the inner and outer rings where the raceways are formed. A chromium nitride film is further formed on the nitrided layer. The layer and film serves to prevent surface-starting peeling and smearing, thus prolonging the life of the bearing.

### BACKGROUND OF THE INVENTION

This invention relates to a rolling bearing, particularly a rolling bearing which is suitable for use in a high-temperature, high-speed, light-load environment.

Rolling bearings for gas turbine spindles and input shafts of speed reduction gears, which are typically used in high-temperature, high-speed, light-load environments, tend to suffer from premature surface-starting peeling or premature smearing of the raceways of the inner and outer rings or the rolling surfaces of the rolling elements. Such premature peeling starts from an impression formed by hard foreign matter that has been stuck in the bearings. Premature smearing results from slipping and skidding of the rolling elements, which tend to occur under light loads. Such peeling and smearing dramatically shorten the life of the bearings.

It has been proposed to prevent surface-starting peeling by forming a nitrided layer comprising a compound layer and a diffused/hardened layer on the raceways of the inner and outer rings (as disclosed in (unexamined) JP patent publication 2001-266872). It has also been proposed to prevent smearing by forming the raceways into a non-circular shape such as a bilobated or trilobated shape, thereby applying a radial preload to the raceways (as disclosed in “Roller Bearing Slip and Skidding Damage” J. AIRCRAFT, Vol. 12, No. 4, April, 1975, page 281-287, by B. A. Tassone).

By forming a hard nitrided layer on the raceways of the inner and outer bearing rings, it is possible to effectively prevent surface-starting peeling. But this layer has no effect on the prevention of smearing, which tends to occur as a result of a high-speed, metal-to-metal sliding movement. On the other hand, it is difficult to determine the level of the radial preload to a suitable value by forming the raceways into a bilobated or trilobated shape. Thus, in a practical sense, there exists no effective way to prolong the life of a rolling bearing that is used in a high-temperature, high-speed, light-load environment by preventing both surface-starting peeling and smearing.

An object of the present invention is to prolong the life of a rolling bearing used in a high-temperature, high-speed, light-load environment, where the bearing tends to suffer from both surface-starting peeling and smearing.

### SUMMARY OF THE INVENTION

According to this invention, there is provided a rolling bearing comprising an inner ring having a radially outer surface formed with a raceway, an outer ring having a radially inner surface formed with a raceway, and a plurality of rolling elements each having a rolling surface and disposed between the raceways formed in the inner and outer rings so as to roll in the raceways, the inner ring, the outer ring and/or the rolling elements being formed of steel, wherein a nitrided layer consisting essentially of a diffusion layer is formed on the raceway of the inner ring, if the inner ring is formed of steel, the raceway of the outer ring, if the outer ring is formed of steel, and/or the rolling surface of each of the rolling elements, if the rolling elements are formed of steel, and a chromium nitride film is formed on the nitrided layer by ion plating.

By forming the nitrided layer and the chromium nitride film, the raceway surfaces and/or the rolling surfaces of the rolling elements are modified such that they are less likely to suffer from smearing. Thus, by forming such layer and film on the raceways and/or rolling surfaces of a rolling bearing used in a high-temperature, high-speed, light-load environment, it is possible to extend the life of the bearing in a stable manner. While the chromium nitride film, which is hard and brittle, tends to suffer from cracks and chipping due e.g. to foreign matter that gets stuck in the bearing if used alone, by forming the chromium nitride film on the nitrided layer formed as a base, it is possible to prevent such cracks and chippings.

The nitrided layer consists essentially of a diffusion layer, because such a hard diffusion layer greatly contributes to the prevention of surface-starting peeling. Such a nitrided layer, i.e. a nitrided layer consisting essentially of a diffusion layer can be formed e.g. by radical nitriding in which ammonium gas and hydrogen gas are subjected to ion nitriding in a plasma environment.

Preferably, the chromium nitride film has a thickness not exceeding 3 micrometers because a chromium nitride film is hard and brittle, so that a chromium nitride film having a thickness exceeding 3 micrometers are more likely to suffer from cracks and chippings.

The rolling elements are preferably formed of a ceramic material to prevent high-speed metal-to-metal slipping, and thereby to prevent smearing.

With this arrangement, it is possible to stably extend the life of a rolling bearing used in a high-temperature, high-speed, light-load environment.

### BRIEF DESCRIPTION OF THE DRAWINGS

Other features and objects of the present invention will become apparent from the following description when taken with reference to the accompanying drawings, in which:

FIG. 1 is a vertical sectional view of a rolling bearing of a first embodiment; and

FIGS. 2 and 3 are vertical sectional views of rolling bearings of second and third embodiments, respectively.

### DETAILED DESCRIPTION OF THE PREFERRED EMBODIMENT

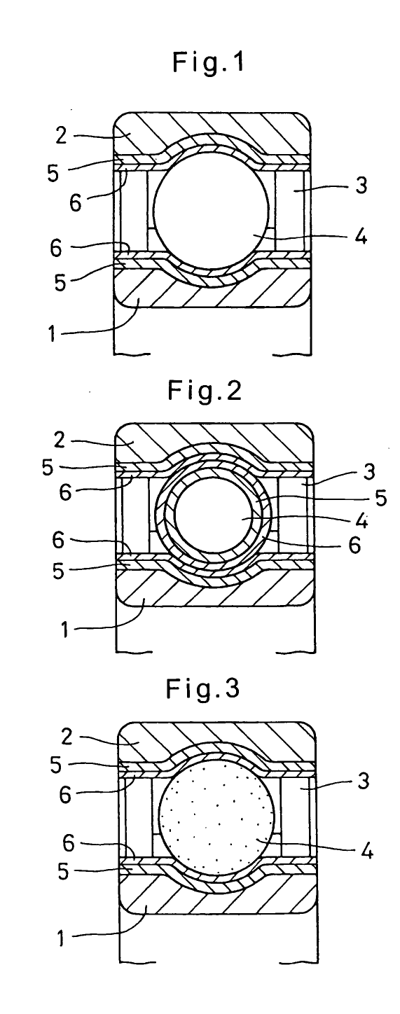

Now the embodiments will be described with reference to the drawings. First referring to FIG. 1, the rolling bearing of the first embodiment is a ball bearing comprising inner and outer bearing rings 1 and 2 formed with radially opposing raceways, and a plurality of balls 4 as rolling elements held by a retainer 3 between the raceways of the inner and outer bearing rings 1 and 2. The inner and outer rings 1 and 2 and the balls 4 are all formed of a heat-resistant bearing steel M50. On each of the surfaces of the inner and outer rings 1 and 2 where the raceways are formed, a nitrided layer 5 consisting essentially of a diffusion layer formed by radical nitriding is formed. On each nitrided layer 5, a chromium nitride film 6 is formed by ion plating.

### EXAMPLES

Cylindrical roller-shaped test specimens and ring-shaped test specimens each formed with a nitrided layer and a chromium nitride film as described above (Examples 1 and 2 according to the Invention) were prepared. Further, cylindrical roller-shaped test specimens and ring-shaped test specimens both not surface-treated (Comparative Example 1), cylindrical roller-shaped test specimens and ring-shaped test specimens both formed with only a nitrided layer as described above (Comparative Example 2), and cylindrical roller-shaped test specimens formed only with a chromium nitride film as described above (Comparative Example 3) were prepared. The roller-shaped test specimens were subjected to rolling fatigue life tests. The ring-shaped test specimens were subjected to smearing tests. All of the test specimens were formed of heat-resistant bearing steel M50.

(1) Rolling Fatigue Life Tests

In these tests, impressions were formed beforehand on the rolling surface of each roller-shaped test specimen using a Vickers hardness tester. Then, the test specimens (seven for each Example) were rolled with radial loads applied thereto. The rolling fatigue life was measured in terms of the L10 life (that is, time period during which 90% of the test specimens were usable with no fatal damage sustained). The tests were conducted under the following conditions. The roller-shaped test specimens measured 12 mm in outer diameter and 12 mm in length.
Maximum contact surface pressure: 4.2 GPa
Loading rate: 20400 times/minute
Lubricating oil: Turbine oil VG56
Vickers impressions: 196 N (9 impressions: axially spaced from each other at 1 mm intervals)

The L10 life measured for each Example is shown in Table 1. In Table 1, the L10 life for each Example is shown in terms of the ratio with respect to the L10 life of Comparative Example 1, in which no treatment was made on the rolling surfaces of the roller-shaped test specimens. This ratio (life ratio) was 1.7 for Example 1 according to the Invention, in which a nitrided layer and a three-micrometer thick chromium nitride film as defined above were formed on the rolling surface of each specimen. This clearly indicates that the test specimens of Example 1 according to the Invention are far less likely to develop surface-starting peeling than Comparative Example 1. The life ratio for Example 2 according to the invention, in which a nitrided layer and a five-micrometer thick chromium nitride film as defined above were formed on the rolling surface of each specimen, was 1.2. This shows that the rolling fatigue life improved less in Example 2 according to the invention than in Example 1 according to the Invention.

The life ratio for Comparative Example 2, in which only a nitrided layer as defined above was formed on the rolling surface of each specimen, was also excellent. For Comparative Example 3, in which only a chromium nitride film as defined above were formed on the rolling surface of each specimen, the L10 life was far inferior to that of Comparative Example 1. The results clearly indicate that a test specimen formed with a hard and brittle chromium nitride film alone on its rolling surface is likely to develop cracks and chippings due e.g. to foreign matter that gets stuck in the bearing, and that by forming such a chromium nitride film on a hard nitrided layer formed on the rolling surface as a base, cracks and chippings can be reduced markedly. But a chromium nitride film having a thickness greater than 3 micrometers tends to lower the degree of improvement in the life ratio.

TABLE 1

| | | Chromium | Life | Relative Speed |
|---|---|---|---|---|
| Specimens | Nitrided Layer | Nitride Film | Ratio | Ratio |
| Example 1 of | Formed | 3 μm | 1.7 | >1.8 |
| the Invention | | | | |
| Example 2 of | Formed | 5 μm | 1.2 | >1.8 |
| the Invention | | | | |
| Comparative | Not formed | Not formed | 1.0 | 1.0 |
| Example 1 | | | | |
| Comparative | Formed | Not formed | 4.9 | <1.0 |
| Example 2 | | | | |
| Comparative | Not formed | 3 μm | 0.2 | — |
| Example 3 | | | | |

(2) Smearing Tests

The test specimens used in these tests were ring-shaped specimens each having a cylindrical outer surface having a moderate radius of curvature as viewed from a direction perpendicular to the axis of the test specimen. A pair of test specimens were mounted on first and second parallel drive shafts, respectively, with their cylindrical surfaces pressed against each other. In this state, the first drive shaft was driven at a constant speed, while the second drive shaft was driven first at the same speed as the first drive shaft and then accelerated gradually. Each test specimen was 40 mm in diameter and 12 mm high with the cylindrical surface having a radius of curvature, as viewed from a direction perpendicular to the axis of the test specimen, of 60 mm. The cylindrical surface was finished to a surface roughness Rmax of 3 micrometers. The smearing strength was determined in terms of the speed ratio of the second drive shaft to the first drive shaft when smearing was observed in one of each pair of test specimens mounted on the shafts. The smearing tests were conducted for the ring-shaped test specimens, i.e. test specimens for Examples 1 and 2 according to the Invention and Comparative Examples 1 and 2 under the following conditions.
Maximum contact surface pressure: 2.1 GPa
rpm of the first drive shaft: 200 rpm
rpm of the second drive shaft: 200 rpm for the first three minutes, then accelerated at the rate of 100 rpm per 30 seconds.
Lubricating oil: turbine oil VG46

In Table 1, the ratio of the speed ratio of the second drive shaft to first drive shaft when smearing was observed for each Example to the corresponding speed ratio for Comparative Example 1 is shown. This ratio, which is referred to as “relative speed ratio” in Table 1, was greater than 1.8 for Examples 1 and 2 according to the Invention, in which both a nitrided layer and a chromium nitride film as defined above were formed. This means that the test specimens of Examples 1 and 2 according to the Invention are superior both in the rolling fatigue life and the smearing strength. In contrast, for Comparative Example 2, in which only a nitrided layer was formed, the smearing strength was even lower than Comparative Example 1, in which no surface treatment was made. These results clearly indicate that forming a chromium nitride film on a nitrided layer formed on the rolling surface greatly contributes to improvement in the smearing strength.

FIG. 2 shows the rolling bearing of the second embodiment, which is also a ball bearing. But in this embodiment, a nitrided layer 5 consisting essentially of a diffusion layer and a chromium nitride film 6 formed by ion plating are formed not only on each of the surfaces of the inner and outer bearing rings 1 and 2 where the raceways are formed but also on the rolling surface of each ball 4.

FIG. 3 shows the rolling bearing of the third embodiment, which is also a ball bearing. In this embodiment, the balls 4 are formed of a ceramic material. The inner and outer bearing rings 1 and 2 are formed of heat-resistant bearing steel M50. A nitrided layer 5 and a chromium nitride film 6 as defined above are formed on each of the surfaces of the inner and outer rings 1, 2 where the raceways are formed.

While the rolling bearings of the embodiments are all ball bearings, the concept of the present invention is equally applicable to other types of rolling bearings including roller bearings and tapered roller bearings as well.

1. A rolling bearing comprising an inner ring having a radially outer surface formed with a raceway, an outer ring having a radially inner surface formed with a raceway, and a plurality of rolling elements each having a rolling surface and disposed between said raceways formed in said inner and outer rings so as to roll in said raceways, said inner ring, said outer ring and/or said rolling elements being formed of steel, wherein a nitrided layer consisting essentially of a diffusion layer is formed on the raceway of said inner ring, if said inner ring is formed of steel, the raceway of said outer ring, if said outer ring is formed of steel, and/or the rolling surface of each of said rolling elements, if said rolling elements are formed of steel, and a chromium nitride film is formed on said nitrided layer by ion plating.

2. The rolling bearing of claim 1 wherein said chromium nitride film has a thickness of not more than 3 micrometers.

3. The rolling bearing of claim 1 wherein said rolling elements are formed of a ceramic material.

4. The rolling bearing of claim 2 wherein said rolling elements are formed of a ceramic material.
